(19) United States
(12) Patent Application Publication
(10) Pub. No.: US 2023/0072412 A1
(43) Pub. Date: Mar. 9, 2023

(54) OVEN

(71) Applicant: Gozney Group Limited, Christchurch Dorset (GB)

(72) Inventor: Thomas Robert Llewelyn GOZNEY, Dorset (GB)

(21) Appl. No.: 17/800,904

(22) PCT Filed: Feb. 15, 2021
(86) PCT No.: PCT/EP2021/053638

§ 371 Date: Aug. 19, 2022

(30) Foreign Application Priority Data
Feb. 19, 2020 (GB) 2002310.7

(51) Int. Cl. A21B 3/04; F24C 15/00; F24C 15/32

(52) U.S. Cl. CPC A21B 3/04; F24C 15/003; F24C 15/327

(57) ABSTRACT

Disclosed is an oven comprising: an oven housing containing an oven chamber for containing foodstuffs to be cooked; an aperture formed in the oven housing for receiving liquid; and a vaporizer configured to receive liquid that is received by the aperture, vaporize the liquid into vapor, and convey the vapor into the oven chamber. Also disclosed is a vaporizer apparatus for use with an oven.

### CROSS-REFERENCE TO RELATED APPLICATIONS

The present application is a U.S. National Stage filing under 35 U.S.C. 371(c) of International Application No. PCT/EP2021/053638, filed Feb. 15, 2021, which claims priority to Great Britain Patent Application No. 2002310.7, filed Feb. 19, 2020, the disclosures of which are hereby incorporated by reference in their entireties.

The present disclosure relates to ovens and is particularly, although not exclusively, concerned with vapour or steam generation in ovens.

### BACKGROUND

Ovens for cooking or curing foodstuffs are known. It may be desired to produce vapor, such as steam, to aid a cooking process.

Steam is conventionally generated by filling a vessel with water or saturating an absorbent item with water, and placing it in the oven chamber to be heated and covert to steam. Alternatively, water may be directly sprayed into the oven chamber. However, these methods have problems, such as taking up valuable space in the oven chamber, being slow to create large volumes of steam, and/or potentially damaging the oven due to thermal shock.

Further developments in steam generation in ovens would be desirable.

### STATEMENTS

According to a first aspect of the present disclosure, there is provided an oven comprising: an oven housing containing an oven chamber for containing foodstuffs to be cooked; an aperture formed in the oven housing for receiving liquid; and a vaporizer configured to receive liquid that is received by the aperture, vaporize the liquid into vapor, and convey the vapor into the oven chamber.

It should be understood that the aperture is a separate opening to an oven mouth of the oven. The aperture may be a dedicated aperture for receiving liquid to be converted into vapor. The liquid may be water, and the vapor may be steam.

Regarding “vaporizer”, “vaporize” and “vaporization”, it should be understood that these terms relate to the conversion of liquid into vapor by evaporation and/or boiling.

The aperture is formed in an exterior surface of the oven housing. Optionally, the aperture is provided on an upper surface of the oven housing.

The vaporizer may be configured such that, in use, liquid received by the vaporizer is vaporized by the heat within the oven chamber.

The vaporizer may comprise a vaporization surface for dispersing liquid for vaporization into vapor. Dispersing should be understood as increasing the surface area of the liquid to promote vaporization. The vaporization surface may be a substantially flat surface over which liquid can spread to thereby increase its surface area. The vaporization surface may comprise surface-area-increasing features, such as fins, undulations, or cavities, to increase the contact area between the liquid and the vaporization surface. This may improve or hasten vaporization of the liquid.

The vaporizer may comprise a vaporization tray for receiving liquid to be vaporized. The vaporization tray comprises the vaporization surface and an elevated peripheral wall around the vaporization surface for retaining liquid on the vaporization surface.

The vaporizer may comprise first and second vaporization trays, which each comprise a respective vaporizer surface and peripheral wall.

The oven may further comprise a liquid divider in communication with the first and second vaporization trays. The oven may be further configured such that liquid introduced into the aperture is directed towards the divider. The divider may be configured so as to direct a first portion of liquid received by the aperture into the first vaporization tray and a second portion of liquid received by the aperture into the second vaporization tray.

In other examples, more than two vaporization trays may be provided, and the divider may direct a portion of liquid into each of the vaporization trays.

The vaporizer may be formed from a sheet material. Optionally, the sheet material may be a sheet metal. The vaporizer may be formed from stainless steel. The vaporizer may therefore be resistant to corrosion.

The vaporization tray may be formed on a first side of the sheet material, optionally an upwardly-facing side in use. An opposing side of the sheet, optionally a downwardly-facing side in use, may be directly exposed to, or within, the oven chamber.

By providing a sheet material which contacts the liquid on a first side, and is exposed to the oven chamber on a second side, heat from the oven chamber can efficiently heat the sheet material and, therefore, heat the liquid to vaporize it.

A periphery of the vaporizer may be sealed against an internal wall of the oven chamber. The vaporizer may therefore form a vaporization chamber between the vaporizer and the internal wall of the oven chamber. A portion, or discrete portions, of the periphery of the vaporizer tray may be sealed against the internal wall, or the entire periphery of the vaporizer tray may be sealed against the internal wall. Where the vaporizer is formed from sheet material, the periphery of the vaporizer may comprise a flange for sealing against an internal wall or the oven. The vaporizer may comprise a first, substantially horizontal portion, and a second substantially upstanding portion, such that the vaporizer can be configured to contact both a side wall and a roof of the oven chamber and, therefore, be arranged at a periphery of the roof of the oven. This may maximise an available volume of the oven chamber for cooking. Arranging the vaporizer proximate a roof of the oven chamber, where the hottest temperatures in the oven may be, may promote more efficient or faster vaporization of the liquid in the vaporizer.

The vaporizer may comprise one or more openings through which vapor generated from liquid in the vaporization tray can travel from the vaporization chamber into the oven chamber. If the vaporizer comprises a substantially horizontal portion and an upstanding portion, the opening(s) may be formed in the upstanding portion. If a plurality of small openings are provided, such as a mesh, grill, or hole array, rather than one or more large openings, this may reduce the possibility of debris entering the vaporizer or vaporization chamber, which might reduce its efficiency or prevent correct operation, whilst still permitting vapor to freely enter the oven chamber.

The oven may further comprise a conduit in communication with the aperture for conveying liquid to be vaporized from the aperture to the vaporizer. The conduit may be arranged to convey liquid directly onto the vaporization surface of the vaporizer. The aperture may form an inlet of the conduit, and an outlet of the conduit may be arranged directly over the vaporization surface, or the divider if present. The conduit may be substantially vertical, such that its inlet (i.e. the aperture) is arranged directly above its outlet and the vaporization surface (or divider) may be arranged directly below the conduit's outlet. This may reduce the distance the liquid is required to travel and minimise the space envelope required for the vaporizer.

The oven may further comprise a funnel comprising an inlet for receiving liquid, a funnel volume for containing liquid, and an outlet, optionally comprising a spout, configured to deliver liquid from the funnel volume into the aperture.

The funnel may be removable such that its outlet can be fitted to the aperture when vapor generation is required, and removed when it is not. The oven may further comprise a bung or cover for sealing the aperture in the oven housing when the aperture and vaporizer are not in use. Accordingly, when vapor production is not required, heat loss via the aperture from the oven chamber is reduced or prevented.

The funnel may further comprise a removable lid for sealing the inlet so as to generate a partial vacuum in the funnel volume as liquid is expelled from the outlet. By sealing the inlet, a partial vacuum may be created as liquid leaves the funnel via the outlet. This may regulate the rate of liquid leaving the funnel (i.e. the rate of liquid being provided to the aperture and the vaporizer), so that vapor can be produced over an extended period of time. Furthermore, by gradually introducing the liquid to the vaporizer rather than inundating it, the vaporizer may maintain a higher temperature and vapor sate the liquid more efficiently and/or quickly.

The funnel volume and funnel outlet may be configured such that, when the funnel is filled with liquid, the liquid is gradually delivered into the aperture over a predetermined period of time, optionally over a period of between 60 seconds and 90 seconds. For some cooking methods, such as baking bread, it may be desirable to provide vapor generation for a set period of time.

The vaporizer may be elevated off an oven floor of the oven chamber. The vaporizer may be configured to project outwardly and/or laterally from the internal wall of the oven. The vaporizer may be formed proximate a roof or uppermost portion of the oven chamber.

The oven may further comprise an oven mouth. The oven may further comprise a door for closing the oven mouth. The oven may further comprise an oven outlet, such as a chimney, for expelling gases from the oven chamber. The oven outlet may comprise a valve, such as a throttle plate, for sealing the oven outlet, or regulating a flow of gas out of the oven outlet.

When the vaporizer is being used, the oven door may be positioned to close the oven mouth, and the valve in the chimney or flue may be closed to seal the oven outlet, to thereby retain the vapor in the oven chamber. The oven door may be provided with a closable vent for selectively permitting vapor to escape from the oven chamber.

According to a second aspect, there is provided a vaporizer apparatus for use with an oven as set out in accordance with the first aspect above. The vaporizer apparatus may comprise the vaporizer, or may comprise the vaporizer and the aperture.

The vaporizer may not be arranged directly over a heat source of the oven. Such an arrangement could have a risk of extinguishing the heat source when liquid is fed to the vaporizer.

To avoid unnecessary duplication of effort and repetition of text in the specification, certain features are described in relation to only one or several aspects of the invention. However, it is to be understood that, where it is technically possible, features described in relation to any aspect of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a front view of an exemplary oven according to the principles of this disclosure;

FIG. 2 is sectional side view of the oven of FIG. 1;

FIG. 3 is a sectional front view of the oven of FIGS. 1 and 2; and

FIG. 4 is a perspective view of an exemplary vaporiser; and

FIG. 5 is a sectional side view of the oven of FIG. 1, further comprising a funnel.

### DETAILED DESCRIPTION

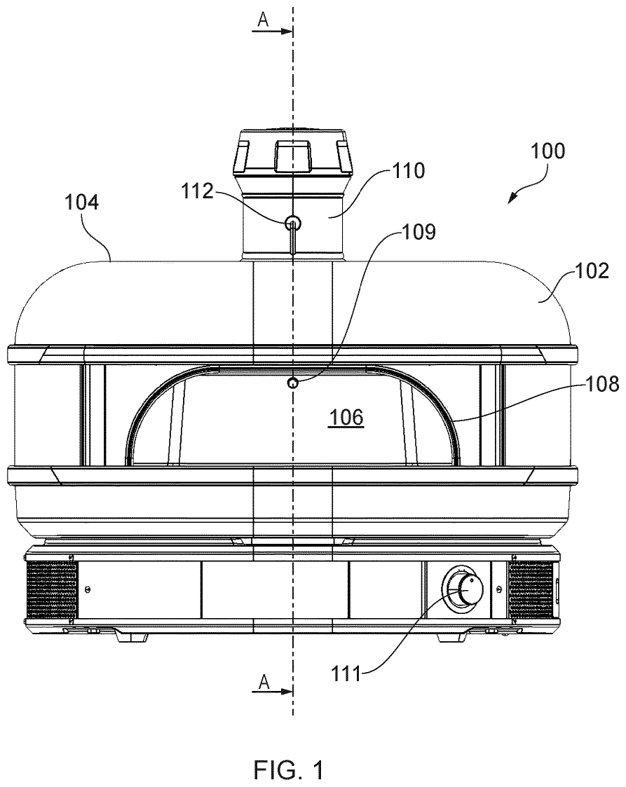

FIG. 1 shows an oven 100 according to the principles of the present disclosure. In this example, the oven could be a domestic oven for use by domestic chefs or a commercial oven for use by commercial chefs. It should be understood that the principles of this disclosure can be applied to many different types of oven.

The oven 100 has an oven housing 102. The oven housing 102 has an outer housing surface 104. The oven housing 102 contains an oven chamber 106 for containing foodstuffs to be cooked. The oven chamber 106 is accessible via an oven mouth 108 on the front of the oven housing 102 to insert and remove items, such as foodstuffs into the oven chamber for cooking and/or curing. When cooking is required, a heat source (not shown) heats the oven chamber to a desired temperature for cooking. A temperature sensor 109, and a heat source adjuster knob 111 are provided for measuring the temperature in the oven, and adjusting the heat source respectively. The heat source may be a gas burner, or may be a solid or liquid fuel burner, such as a wood fire. It should be understood that, although the heat sources in these specific examples utilize gas and/or solid fuel, ovens utilizing electrical energy sources, such as radiant elements or fan heaters are equally possible within the principles of this disclosure.

A further temperature dial may be provided to indicate the temperature of the oven chamber. The temperature dial could be configured with a standalone sensor from the temperature sensor 109, or could use data from the temperature sensor 109.

The oven 100 further comprises a chimney 110 which is in communication with the oven chamber 106, to expel gases within the oven chamber 106. The chimney 110 in this example comprises a throttle valve 112 for sealing or regulating the flow of gases out of the oven chamber 106 via the chimney 110. Arrows E show the path that gases may take when exiting the oven chamber 106 via the chimney 110.

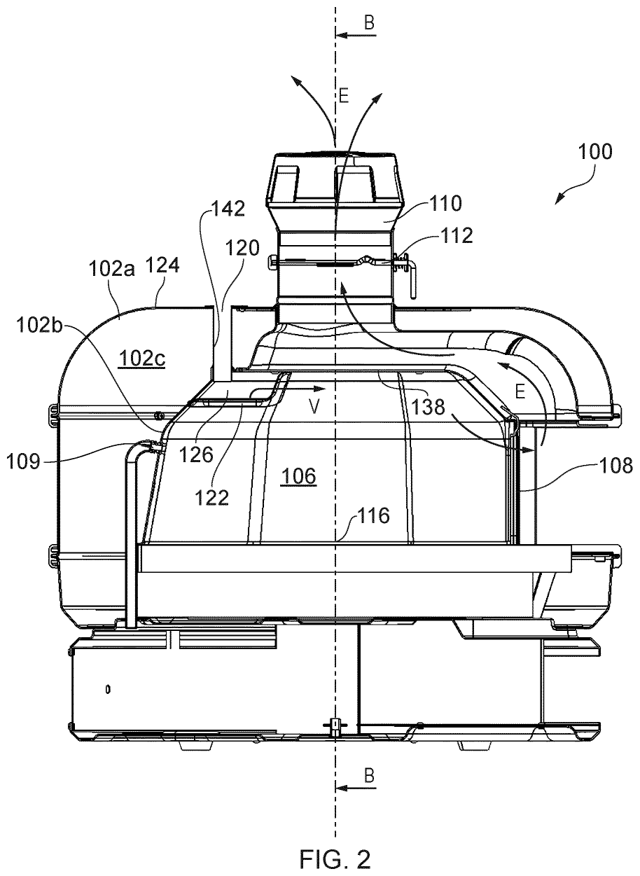

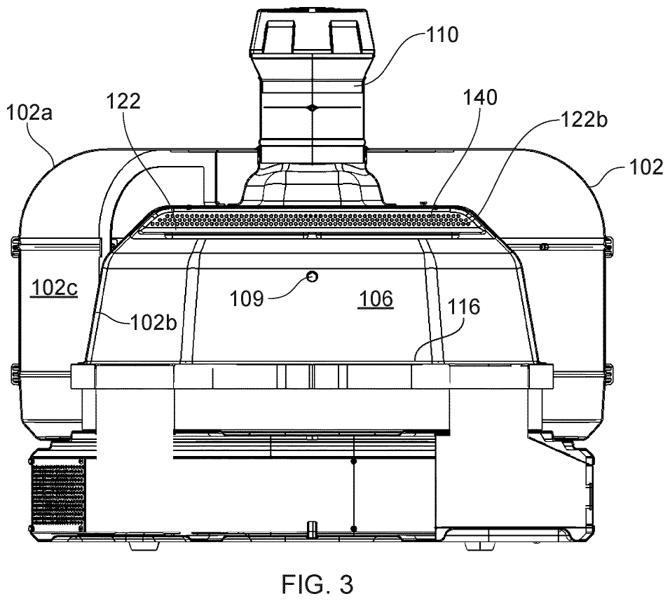

FIG. 2 shows a side sectional view of the oven 100 along the plane A-A shown in FIG. 1 in the direction of the arrows. The internal construction of the oven 100 can be seen more clearly in FIG. 2. The internal construction of the oven is also shown in FIG. 3, which shows a front sectional view of the oven along the plane B-B shown in FIG. 2 in the direction of the arrows.

Referring to FIGS. 2 and 3, the oven 100 will be described further.

As can be seen in FIG. 2, the oven chamber 106 is formed centrally within the oven housing 102. The oven housing 102 comprises an outer housing layer 102a, which defines the outer housing surface 104 of the oven, and an inner housing layer 102b, which defines the oven chamber 106. An insulating cavity 102c is formed between the layers 102a, 102b to reduce the temperature of the outer housing layer 102a for safety. The oven chamber 106 has an oven floor 116, which is formed from a thick stone, which retains heat for cooking the underside of foodstuffs placed in the oven.

For some types of cooking, such as baking, it may be desired or required to produce vapor, and in particular water vapor or steam, to aid the cooking process. The oven 100 therefore comprises a vaporization apparatus 118. The vaporization apparatus 118 comprises an aperture 120 formed in the oven housing 102 for receiving liquid, and a vaporizer 122. The vaporizer 122 is configured to receive liquid from the aperture 120 and to vaporize that liquid into vapor, and convey the vapor into the oven chamber 106.

The aperture 120 is, in this example, formed on an uppermost surface or roof 124 of the oven 100. The aperture 120 is an entirely separate opening to the oven mouth 108 of the oven 100. The aperture 120 is dedicated to receiving liquid, usually water, to be converted into vapor. We will refer to the generic terms “liquid” and “vapor” throughout this description, but it should be understood that these terms could be swapped for “water” and “steam” respectively in one specific example. Regarding “vaporizer”, “vaporize”, and “vaporization”, it should be understood that these terms relate to the conversion of liquid into vapor by evaporation and/or boiling.

It is evident that the aperture 120 is formed in the exterior surface 104 of the oven housing 102. Accordingly, the aperture is easily accessible by a user to generate vapor without requiring access to the interior of the oven chamber 106, such as via the oven mouth 108. In this example, the vaporizer 122 forms a vaporizer chamber 126 between the vaporizer 122 and the internal surface of the oven chamber 106 defined by the inner housing layer 102b.

Turning now to the vaporizer 122, it will be understood that it is configured such that, when the oven chamber 106 is heated in use, liquid received by the vaporizer 122 will be heated and, thus, vaporized by the heat within the oven chamber 106.

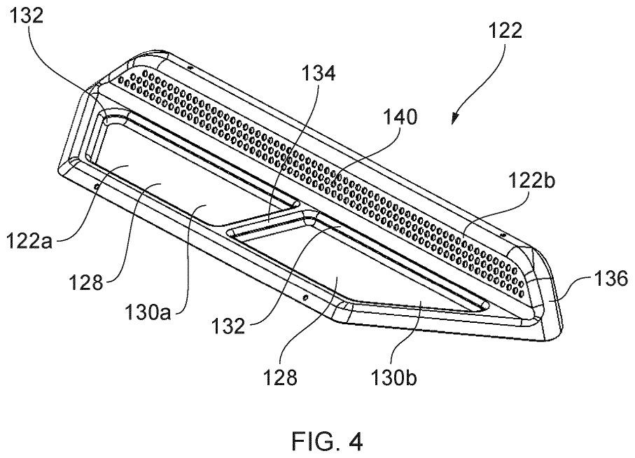

An exemplary vaporizer 122 is shown in more detail in FIG. 4, which illustrates a perspective view of the upper/internal surface of the vaporizer 122.

As can be seen, the vaporizer 122 comprises a vaporization surface 128 for dispersing liquid for vaporization into vapor. In this example, the vaporization surface 128 is a wide, flat surface for dispersing liquid so as to increase the surface area of the liquid to promote vaporization. In other examples, the vaporization surface 128 could have surface-area-increasing features, such as fins, undulations, or cavities, to increase the contact area between the liquid and the vaporization surface. This could further improve or hasten vaporization of the liquid.

Additionally, or alternatively, the vaporizer 122 may be provided with a mass of material (not shown), such as stone or cast iron, which is configured to add thermal mass to the vaporizer 122 this mass may enable the vaporizer to heat liquid more quickly and maintain a higher temperature during vaporization.

The vaporizer 122 in this example comprises two vaporization trays 130a and 130b for receiving liquid to be vaporized. The vaporization trays 130a,b comprise a respective vaporization surface 128 and an elevated peripheral wall 132 around the vaporization surface 128 which serves to give the tray 130 depth and thereby retain liquid on the vaporization surface 128. In other examples, only a single vaporization surface or tray may be provided, or more than two may be provided. If one or more masses of material to increase thermal mass are provided, it or they may be located in the vaporization tray or trays.

Also, in this example, the oven, and in particular the vaporizer 122, features a liquid divider 134 which is in communication with the first and second vaporization trays 130a,b. The liquid divider 134 in this example is a ridge formed between the two vaporization trays 130a,b. It will be understood that liquid introduced into the aperture 120 is directed towards the liquid divider 134, and the divider 134 will deflect a first portion of the liquid received by the aperture 120 into the first vaporization tray 130a and a second portion of liquid received by the aperture 120 into the second vaporization tray. In other examples, more than two vaporization trays may be provided, and it should be understood that a divider may direct a portion of liquid into each of the vaporization trays.

In this example, the vaporizer is formed from a sheet material and, in particular, stainless steel. The vaporizer 122 of this example therefore be resistant to corrosion. As will be appreciated from considering FIGS. 2 and 4, the vaporization trays 130a,b, which hold and distribute liquid for vaporization are formed on an upwardly-facing side of the vaporizer 122, while the opposing downwardly-facing side of vaporizer 122, is directly exposed to the oven chamber 106. By providing the vaporizer 122 as a thin, thermally-conductive sheet material which contacts the liquid on a first side, and is exposed to the oven chamber 106 on a second side, heat from the oven chamber can efficiently heat the sheet material and, therefore, heat the liquid to vaporize it.

The vaporizer 122 has, at its periphery, a flange 136 for sealing against the internal wall of the oven chamber, which is formed by the internal housing layer 102b. Accordingly, the vaporizer 122 may form the vaporization chamber 126 between itself and the internal wall of the oven chamber 106. In this example, the entire periphery of the vaporizer 122 is sealed against the internal wall but, in other examples, a portion, or discrete portions, of the periphery of the vaporizer may be sealed against the internal wall.

As can be appreciated, the exemplary vaporizer 122 comprises a first, substantially horizontal portion 122a, and a second substantially upstanding portion 122b, such that the vaporizer 122 has a generally L-shaped cross-section along its width. This configuration permits the vaporizer 122 to contact both a side wall 102b and a roof 138 of the oven chamber 106 and, therefore, be arranged at a periphery of the roof 138 of the oven chamber 106. The vaporizer trays 130a,b are configured on the horizontal portion 122a, such that they are arranged to receive and contain liquid. The vaporizer 122 is generally configured to project outwardly or laterally from the internal wall of the oven chamber 106.

This configuration of the vaporizer 122 may further increase an available volume of the oven chamber 106 for cooking. Arranging the vaporizer 122 proximate the roof 138 of the oven chamber, where the hottest temperatures in the oven may be, may promote more efficient or faster vaporization of the liquid in the vaporizer. In this example, the vaporizer 122 is not arranged directly over a heat source of the oven 100 because such an arrangement could have a risk of extinguishing the heat source when liquid is fed to the vaporizer.

The vaporizer 122 in this example comprises an array of openings 140 through which vapor generated from liquid in the vaporization tray can travel from the vaporization chamber into the oven chamber. The openings 140 are formed on the upstanding portion 122b of the vaporizer 122. In other examples, one or more larger openings could be provided. However, by providing a plurality of small openings, such as a mesh, grill, or hole array as per this example, rather than one or more large openings, this may reduce the possibility of debris entering the vaporizer 122 or vaporization chamber 126, which might reduce its efficiency or prevent correct operation, whilst still permitting vapor to freely enter the oven chamber 106.

Generally, it should be understood that the exemplary vaporizer 122 and other examples enable the vaporizer 122 to be elevated off the oven floor 116 of the oven chamber 106. This may maximize an available area of the oven floor 116 for cooking.

Referring back to FIG. 2, it can be appreciated that the oven further comprises a conduit 142 in communication with the aperture 120 for conveying liquid to be vaporized from the aperture to the vaporizer 122. The aperture 120 forms an inlet of the conduit 142, and the outlet of the conduit 142 is arranged directly over the vaporizer 122, and in particular, over the divider 134. The conduit 142 is substantially vertical, such that its inlet (i.e. the aperture 120) is arranged directly above its outlet and the vaporizer 122 is arranged directly below the conduit's outlet. This can serve to reduce the distance the liquid is required to travel and minimize the space envelope required for the vaporizer 122. It will be understood that, in examples where there is some distance or wall thickness between the outer surface of the oven and the oven chamber, a conduit can be provided to covey liquid to the vaporizer 122 from the aperture 120. Many different configurations are feasible within the principles of this disclosure. In other examples, where the wall thickness of the oven is minimal, the aperture may simply be arranged directly over the vaporizer, without a conduit to direct liquid.

The oven 100 further comprises a bung or cover (not shown) for sealing the aperture 120 when the aperture 120 and vaporizer 122 are not in use. Accordingly, when vapor production is not required, heat loss via the aperture 120 from the oven chamber 106 is reduced or prevented.

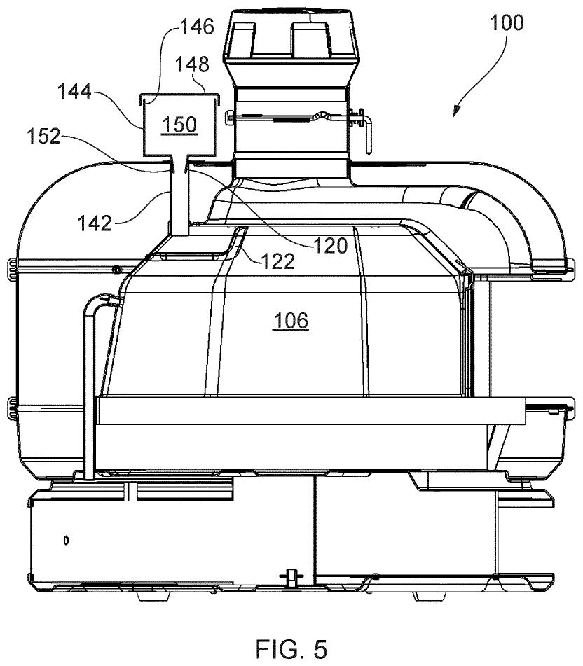

Referring now to FIG. 5, the oven 100 is shown in use with a further optional component in a side perspective view corresponding to FIG. 2. In this example, the oven 100 is provide with a funnel 144. The funnel 144 has an inlet 146 for receiving liquid, which in FIG. 6 is covered by a lid 148, a funnel volume 150 for containing liquid, and an outlet 152, which comprises a spout, configured to deliver liquid from the funnel volume 150 into the aperture 120. The funnel 144 is removable such that its outlet 152 can be fitted into the aperture 120 when vapor generation is required, and removed when it is not. The funnel outlet 152 has a much smaller cross sectional area than the inlet 146 and the funnel volume 150, such that liquid contained in the volume 150 drains slowly from the outer 152.

The funnel's lid 148 is removable. When vapor generation is required, the lid 148 is removed, and liquid (in this case, water) is provided to fill the funnel volume 150. The lid 148 is then quickly replaced to seal the inlet 146. As water drains from the funnel 144 via the outlet 152, a partial vacuum is formed in the funnel volume 150 due to the seal between the lid 148 and the funnel inlet 16. This regulates the rate of liquid leaving the funnel 144 (i.e. the rate of liquid being provided to the aperture 120 and the vaporizer 122), so that vapor can be produced over an extended period of time. Furthermore, by gradually introducing the liquid to the vaporizer 122 rather than inundating it with all of the liquid at one time, the vaporizer 122 may maintain a higher temperature and vaporize the liquid more efficiently and/or quickly.

The funnel volume 150 and funnel outlet may be configured such that, when the funnel is filled with liquid, the liquid is gradually delivered into the aperture over a predetermined period of time, optionally over a period of between 60 seconds and 90 seconds. For some cooking methods, such as baking bread, it may be desirable to provide vapor generation for a set period of time. This can be achieved by providing a funnel volume 150 of a predetermined volume and a funnel outlet 152 of a predetermined size such that, when the funnel volume 150 is filled completely with water, or to a fill line, the time for ejecting all of the water in the volume 150 is known.

The oven may further comprise a door for closing the oven mouth (not shown). When the vaporizer 122 is being used to generate vapor for the oven chamber 106, the oven door may be positioned to close the oven mouth 108, and the valve 112 in the chimney 110 may be closed to seal the oven, to thereby retain the vapor in the oven chamber 106.

It should be appreciated that the oven, and vaporizer apparatus disclosed herein may provide many advantages over prior art systems. The systems and apparatus disclosed herein may provide safer vapor generation, as access to the oven chamber is not required. Furthermore, the location and size of the vaporizer apparatus achievable with the present disclosure may mazimize oven chamber volume and oven floor area available for cooking. The vaporizer may better produce vapor in a quicker or more efficient way owing to its structure and positioning. Additionally, the construction of the vaporizer may minimize deformation and stress due to the temperature changes inherently involved in vapor generation, and thereby protect the oven from damage.

To avoid unnecessary duplication of effort and repetition of text in the specification, certain features are described in relation to only one or several aspects of the invention. However, it is to be understood that, where it is technically possible, features described in relation to any aspect of the invention may also be used with any other aspect of the invention.

It will be appreciated by a skilled person that although the invention has been described by way of example, with reference to exemplary examples, it is not limited to the disclosed examples and that alternative examples could be constructed without departing from the scope as defined by the appended claims.

1. An oven comprising:
an oven housing containing an oven chamber for containing foodstuffs to be cooked;
an aperture formed in the oven housing for receiving liquid; and
a vaporizer configured to receive liquid that is received by the aperture, vaporize the liquid into vapor, and convey the vapor into the oven chamber.

2. An oven as claimed in claim 1, wherein the vaporizer is configured such that, in use, liquid received by the vaporizer is vaporized by the heat within the oven chamber.

3. An oven as claimed in claim 1, wherein the vaporizer comprises a vaporization surface for dispersing liquid for vaoorization into vapor.

4. An oven as claimed in claim 3, wherein the vaporizer comprises a vaporization tray for receiving liquid to be vaporized, the vaporization tray comprising the vaporization surface and an elevated peripheral wall around the vaporization surface for retaining liquid on the vaporization surface.

5. An oven as claimed in claim 4, wherein the vaporizer comprises first and second vaporization trays each comprising a respective vaporizer surface and peripheral wall.

6. An oven as claimed in claim 5, further comprising a liquid divider in communication with the first and second vaporization trays.

7. An oven as claimed in claim 6, wherein the oven is configured such that liquid introduced into the aperture is directed towards the divider, and wherein the divider is configured so as to direct a first portion of liquid received by the aperture into the first vaporization tray and a second portion of liquid received by the aperture into the second vaporization tray.

8. An oven as claimed in claim 4, wherein the vaporizer is formed from a sheet material, optionally a sheet metal.

9. An oven as claimed in claim 8, wherein the vaporization tray is formed on a first side of the sheet material, optionally an upwardly-facing side in use, and
wherein an opposing side of the sheet, optionally a downwardly-facing side in use, is directly exposed to, or within, the oven chamber.

10. An oven as claimed in claim 4, wherein a periphery of the vaporizer is sealed against an internal wall of the oven chamber, so as to form a vaporization chamber between the vaporizer and the internal wall of the oven chamber.

11. An oven as claimed in claim 10, wherein the vaporizer comprises one or more openings through which vapor generated from liquid in the vaporization tray can travel from the vaporization chamber into the oven chamber.

12. An oven as claimed in claim 10, further comprising a conduit in communication with the aperture for conveying liquid to be vaporized from the aperture to the vaporizer.

13. An oven as claimed in claim 10, wherein the oven further comprises a funnel comprising an inlet for receiving liquid, a funnel volume for containing liquid, and an outlet, optionally comprising a spout, configured to deliver liquid from the funnel volume into the aperture.

14. An oven as claimed in claim 13, wherein the funnel further comprises a removable lid for sealing the inlet so to as to generate a partial vacuum in the funnel volume as liquid is expelled from the outlet.

15. An oven as claimed in claim 13, wherein the funnel volume and funnel outlet are configured such that, when the funnel is filled with liquid, the liquid is gradually delivered into the aperture over a predetermined period of time, optionally over a period of between 60 seconds and 90 seconds.

16. An oven as claimed in claim 13, wherein the vaporizer is elevated off an oven floor of the oven chamber.

17. A vaporizer apparatus for use with an oven as claimed in claim 13.
